(19) United States
(12) Patent Application Publication
(10) Pub. No.: US 2023/0151281 A1
(43) Pub. Date: May 18, 2023

(54) PROCESS TO PREPARE A GAS OIL PRODUCT

(71) Applicant: Raymond Paul FLETCHER, Amsterdam (NL)

(72) Inventor: Raymond Paul FLETCHER, Amsterdam (NL)

(21) Appl. No.: 18/055,478

(22) Filed: Nov. 15, 2022

Related U.S. Application Data
(60) Provisional application No. 63/279,767, filed on Nov. 16, 2021.

(51) Int. Cl. C10G 1/02; B01D 3/10; C10B 53/02; C10B 49/22

(52) U.S. Cl. CPC C10G 1/02; B01D 3/10; C10B 53/02; C10B 49/22; C10G 2300/1014; C10G 2300/4012; C10G 2400/06

(57) ABSTRACT

The invention is directed to a process to prepare a gas oil product from a carbonaceous particles of a biomass source comprising the following steps:
(a) pyrolysis of the carbonaceous particles to a gaseous mixture of hydrocarbons in the absence of oxygen,
(b) quenching the gaseous mixture of hydrocarbons by contacting with a liquid quench mixture of hydrocarbons having a lower temperature than the gaseous mixture thereby obtaining a rich liquid quench mixture and a quenched gas, and
(c) isolating from the quenched gas a gas oil product by means of vacuum distillation, wherein the liquid gas oil is partly supplied to the top of the vacuum distillation column as a distillation reflux, partly used as part of the liquid quench mixture in (b) and partly discharged as the gas oil product.

### CROSS-REFERENCE TO RELATED APPLICATIONS

This application claims benefit under 35 U.S.C. § 119(e) of U.S. Provisional Application No. 63/279,767 filed Nov. 16, 2021, the contents of which are incorporated herein by reference in their entirety.

The invention is directed to a process to prepare a gas oil product from carbonaceous particles of a biomass source by converting the carbonaceous particles at thermal conversion conditions to a gaseous mixture comprising of hydrocarbons isolating from the gaseous mixture a gas oil product by means of distillation.

WO91/11499 describes in its introductory part that historically pyrolysis of carbonaceous materials was performed by so called slow pyrolysis which yielded roughly equal proportions of non-reactive solids, like char and ash, liquid products and non-condensable gases. It was found that fast pyrolysis yielded more valuable chemicals and fuels at the expense of the undesirable slow pyrolysis products. The fast pyrolysis is described to take place at a temperature between 350 and 800 C at a solids residence time of between 30 ms to 2 seconds. The reaction products are reduced to a temperature below 350° C. within 0.5 seconds. Various reactors are described such as a fluidised bed reactor. It is mentioned that in such a reactor the short solid residence time for fast pyrolysis cannot be achieved. Vacuum pyrolysis is mentioned as advantageous to achieve a high liquid products yield. However vacuum pyrolysis is described to be disadvantageous because of heat transfer limitations, difficulty associated with scale up of vacuum processes and the potential of inadequate solids flow. The proposed process of this publication involves a vertical entrained bed transport reactor where the solid carbonaceous feed contacts a recirculating solid heat carrier. The recirculating heat carrier is isolated from the reaction products and separately reheated before being contacted with fresh feedstock. The pyrolysis products are quenched with the liquid product. Warm liquid is drawn from the bottom of the primary condenser and cooled. The cooled liquids are sprayed back into the top of the condenser as quench medium.

More recent publications like for example WO2012/115754 describe a similar fast pyrolysis process involving a circulating heat carrier, which may be sand particles. The illustrated process involves a reheater where pyrolysis char is combusted to directly heat the heat carrier.

A disadvantage of the process of WO91/11499 is that the recovery of a gas oil product is difficult due to the presence of the high boiling fraction of tar produced in pyrolysis reactors. The presence of these tars make it difficult to recover high volumes of the gas oil product from the pyrolysis product.

The aim is to provide a process in which the gas oil product can be isolated in an improved manner which does not have the disadvantages of the prior art processes.

This aim is achieved by the following process. Process to prepare a gas oil product from a carbonaceous particles of a biomass source comprising the following steps,

(a) pyrolysis of the carbonaceous particles to a gaseous mixture of hydrocarbons in the absence of oxygen,

(b) quenching the gaseous mixture of hydrocarbons by contacting with a liquid quench mixture of hydrocarbons having a lower temperature than the gaseous mixture thereby obtaining a rich liquid quench mixture and a quenched gas and

(c) isolating from the quenched gas a gas oil product by means of vacuum distillation, wherein the liquid gas oil is partly supplied to the top of the vacuum distillation column as a distillation reflux, partly used as part of the quench mixture in (b) and partly discharged as the gas oil product.

The applicant found that by performing steps (b) and (c) according to this invention an efficient isolation of a gas oil product can be achieved. Further advantages will be described below when discussing the preferred embodiments.

The carbonaceous particles of a biomass source may be particles of wood, forestry residues, or fibrous biomass such as agricultural residues, such as for example, corn residues, straw, wheat residues, rice residues, switchgrass & other fibrous biomass. Further sources may be green urban waste, cotton gin residue, any type of wood, for example palm fronds, cedar, mesquite, oak, spruce, poplar, willow, and bamboo, wood harvesting residue, like for example limbs, stumps and roots, animal waste, like manure, wood waste, cardboard, construction debris, demolition debris, railroad ties, used pallets, furniture waste and municipal waste.

The size of the carbonaceous particles may be expressed in its largest and smallest dimension. Preferably more than 90 wt % of the particles have a smallest dimension of above 0.3, preferably above 0.5 cm and a largest dimension of smaller than 2.5 and preferably smaller than 1.3 cm.

The particles may be chips, pellets, or shredded vegetable waste such as wood pellets.

The pyrolysis of the carbonaceous particles to a gaseous mixture of hydrocarbons in the absence of oxygen in step (a) may be performed as a fast pyrolysis as for example described in the earlier referred to WO91/11499 and WO2012/115754. In a fast pyrolysis, also known as flash pyrolysis, the carbonaceous particles are subjected to a temperature of between 500° C. and 600° C. for a very short time, typically between 0.5 and 2.0 seconds. The absolute pressure will suitably be between 50 kPa and 155 kPa. At the end of the pyrolysis the gaseous products are quickly reduced in temperature. This may be by the quenching as described for step (b) with the liquid product as described in WO91/11499. Cooling may also be achieved by indirect heat exchange followed by a quenching step (b). Step (a) is suitably performed in the absence of added catalysts, such as the catalyst as described in US2019/0153324. This publication describes porous heterogeneous catalysts onto which one or more metals of Group 6, Group 9 or Group 10 of the Table of Elements are incorporated.

Preferably pyrolysis of the carbonaceous particles to a gaseous mixture of hydrocarbons in the absence of oxygen in step (a) is performed as a slow pyrolysis process at a temperature of between 500 and 1300 C and preferably between 800 and 1050° C., at a pressure of between 0.7 kPa and 35 kPa and at a particles residence time of between 20 and 120 seconds. It has been found that the best quality gas oil product is prepared when the pressure is near vacuum. Suitably the pressure is between 3.0 kPa and 13.7 kPa. Near vacuum pressures for step (a) are preferred because step (c) is also performed at such lower pressures.

The preferred solids residence time will depend on the type of biomass. Preferred residence time for carbonaceous particles of a wood biomass is between 100 and 120 seconds. For less woody biomass, like for example fibrous biomass like for example straw, corn, rice and cotton residues, the optimal solid residence time is suitably lower and in the range of 20 to 100 seconds.

The thermal conversion conditions of step (a) are suitably achieved by contacting the carbonaceous particles with a gas at a temperature of between 500 and 1100° C. and preferably between 800 and 1050° C. The temperature may be achieved by any means such as indirect heat exchange or by using a solid heat carrier. Preferably the temperature conditions are achieved by contacting the carbonaceous particles with a gas having an elevated temperature of suitably between 1000 and 1500° C. Using a heated gas instead of a solid heat carrier is advantageous because it avoids having to recirculate and heat up the solid heat carrier. Such a recirculation and heating of solids is more complex than having to increase the temperature of a gas, such as a hydrogen comprising gas.

The gas is a gas which does not contain oxygen. Examples of possible gases are carbon dioxide, nitrogen or their mixtures.

The above preferred slow pyrolysis process is suitably performed in a fluidised bed reactor. The fluidised bed reactor suitably comprises a bubbling fluidising bed of the carbonaceous particles to which fluidising bed the gas is supplied as a fluidising gas and from which fluidising bed the gaseous mixture is discharged upwardly and away from the fluidising bed. The fluidising particles will in a continuous process be a mixture of the carbonaceous particles and char particles. The char particles may be fully converted in step (a). It has been found that it is more advantageous to obtain the char particles as a secondary product of the slow pyrolysis process. This is possible because the char is not necessarily required to be fully combusted to provide for the required heat to conduct the pyrolysis reaction as in the prior art processes. By obtaining the char particles as a separate secondary product a more sustainable process is obtained because the char can be used as a fertiliser, a filter component, or as a source of graphene. Char is valuable as a fertilizer in that the minerals present in the char can be recycled to the soil for growing fresh biomass.

The gas is supplied to the fluidising bed at a velocity of suitably more than 0.25 m/s and preferably between 1 and 2 m/s. Preferably the gravitational force on the particles is in counterbalance with the drag force of the upwardly flowing gas. The gas velocity at which this happens is referred to as the incipient fluidization velocity. The process is thus preferably performed gas just above the incipient fluidization velocity. In this way less of the particles are entrained with the gas. Any such entrained particles are preferably separated from the gaseous mixture which is discharged upwardly by means of one or more cyclones. Such cyclones may suitably be positioned in the upper part of such a vessel. In this way the separated particles can be easily returned to the fluidised bed of particles.

The gas may be supplied to the fluidised bed reactor via a perforated plate or a perforated dome and more preferably via a gas distribution pipe grid that extends across the cross-sectional area of the reactor. Such inlet systems are well known in the field of fluidisation.

The carbonaceous particles of a biomass source may be supplied to the bubbling fluidised bed reactor via a supply conduit preferably by means of gravity and pressure. Preferably the supply of carbonaceous particles is performed continuously.

The char particles and the gaseous mixture are separately discharged from the bubbling fluidised bed reactor. The gaseous mixture is suitably discharged at the upper end of the bubbling fluidised bed reactor, optionally via one or more cyclones. The char particles may be removed by discharging part of the fluidised particles from the bubbling fluidised bed. This may be achieved by for example a non-symmetrical collection hopper below an optional gas distribution grid to prevent bridging of the char or via an overflow well permanently fixed above the gas distribution grid in order to control bed depth. The overflow pipe may be in the shape of a non-symmetrical hopper.

The char particles as discharged are suitably cooled. Preferably the cooling is performed by means of an indirect heat exchange. Suitably the cooling medium is evaporating boiler feed water. Any entrained gasses are separated from the cooled char particles, suitably by means of a cyclone. The separated gasses may be combined with the overhead gas as described below.

From the gaseous mixture any entrained particles are removed, preferably by means of a cyclone, preferably two cyclones in series. In a bubbling bed reactor more than one of such series of cyclones may be present and suspended from the roof of the reactor vessel.

In step (b) the gaseous mixture of hydrocarbons is quenched by contacting with a liquid quench mixture of hydrocarbons having a lower temperature than the gaseous mixture. In this quenching step a rich liquid quench mixture and a quenched gas is obtained. Part of the higher boiling compounds in the gaseous mixture will condense in the quenching step (b) and become part of the rich quench liquid.

The liquid quench mixture comprises part of the gas oil product. The liquid quench liquid further suitably comprises hydrocarbons having a higher boiling point than the gas oil product. The fraction of hydrocarbons having a higher boiling point than the gas oil product preferably boil for 90 wt % above 260° C. Such hydrocarbons may suitably be part of the rich liquid quench liquid. Another part of the rich quench liquid is discharged as a tar fraction. This tar fraction may be send to a storage. The rich quench liquid is suitably reduced in temperature. The temperature of the liquid quench mixture used in step (b) is at least 150° C. lower and preferably at least 300° C. lower than the temperature of the rich liquid quench mixture which is obtained in step (b).

The temperature of the liquid mixture of hydrocarbons to be used in the quenching step is suitably at least 150° C., preferably at least 300° C., lower than the temperature of the rich quench liquid.

The quenching step (b) is preferably performed in a counter-current operated process step where the gaseous mixture flows upward and the liquid mixture of hydrocarbons flows downwardly. Preferably the counter-current gas-liquid contacting is enhanced by performing the contacting in a packed bed or on one or more distillation trays. Examples of possible distillation trays are bubble cap trays, sieve deck trays, dual flow trays, valve trays and baffle trays. Step (b) is preferably performed at the same low pressures as step (c).

Step (c) is suitably performed by means of vacuum distillation wherein a residue stream is discharged at a lower end of a vacuum operated distillation column. The vacuum distillation is suitably performed at an absolute pressure of between 0.7 and 145 kPa. The overhead stream is cooled such that substantially the hydrocarbons boiling in the gas oil range and above condense and the hydrocarbons boiling below the gas oil range remain gaseous. By performing a gas-liquid separation an overhead gas comprising hydrogen, fuel gas compounds and a naphtha fraction and a liquid gas oil fraction is obtained. Part of the liquid gas oil fraction is returned as a reflux stream to the vacuum distillation column and part of the liquid gas oil fraction is obtained as the gas oil product. A further part of the liquid gas oil fraction is used, suitably in admixture with a distillation residue, to quench the gaseous mixture having an elevated temperature as it is discharged from the fluidised bed reactor. From the overhead stream and especially from the gaseous fraction obtained in the gas-liquid separator a liquid naphtha product can be isolated.

The overhead gas comprising hydrogen, fuel gas compounds and a naphtha fraction is suitably compressed and separated into a hydrogen rich fraction, a fuel gas, naphtha fraction, and a water fraction. The hydrogen rich fraction and/or the fuel gas is preferably used as fuel in a furnace to heat up the gas used in step (a). The naphtha fraction may be discharged as a separate product of this process and may find use as a fuel blending component or as a feed for a process to prepare chemicals such as lower olefins.

The quenching step may be performed in a vessel which is separate from the vacuum operated distillation column or in a lower part of the vacuum operated distillation column. In such an operation the afore mentioned packed bed or distillation trays are present in the lower part of the vacuum operated distillation column. A liquid quench mixture will then be supplied to the upper end of the packed bed or distillation trays such to counter currently contact an upwardly flowing gaseous mixture. The rich quench liquid is discharged from the vacuum operated distillation column at an elevation below the packed bed or distillation trays and is in effect the residue of the vacuum distillation.

The invention will be illustrated by the following Figures.

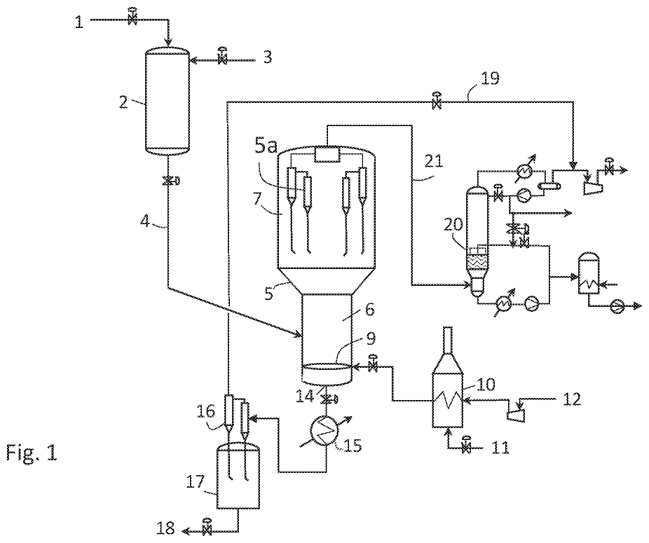

FIG. 1 shows a process scheme for performing the process according to this invention. Via flow (1) carbonaceous particles of a biomass source are provided to a lock hopper vessel (2). To this vessel (2) nitrogen is supplied via flow (3) to replace any air present in the particles. The carbonaceous particles are supplied to a fluidised bed reactor (5) via conduit (4). The fluidised bed (5) has a lower part (6) and an upper part (7) having a larger diameter than the lower part. In the lower part (6) a bubbling fluidised bed of particles is present. The wider diameter of the upper part (7) will avoid entrainment of particles with the gaseous mixture which is discharged from the bubbling bed of particles. A fluidising gas is supplied to the fluidised bed via a gas distribution pipe grid (9). The fluidising gas is heated in a furnace (10) using a fuel gas (11). The fuel gas (11) is preferably isolated from the gaseous overhead stream of the vacuum distillation column (20).

Char particles are discharged from the fluidised bed reactor (5) at a char particles outlet (14). The hot char particles are cooled in heat exchanger (15) against evaporating boiler feed water generating steam. Any entrained gasses are separated from the cooled char particles in two cyclones (16) wherein the char particles are collected in char collection vessel (17) and discharged as a separate char product (18). The separated gasses are combined with the gaseous overhead stream of the vacuum distillation column (20) via flow (19).

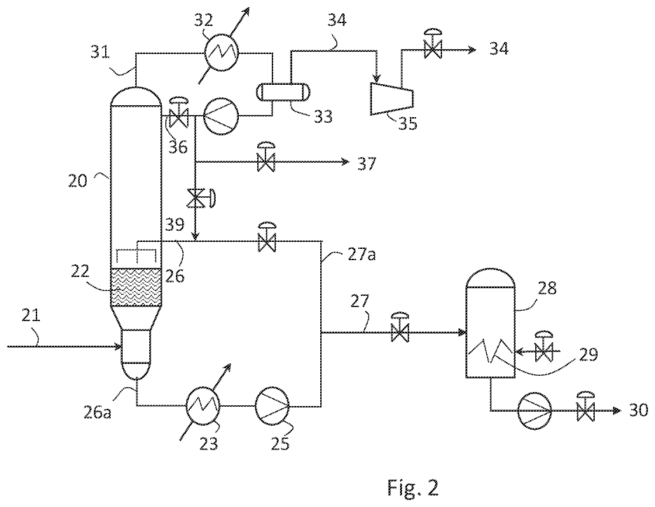

The gaseous mixture is discharged from the fluidised bed reactor (5) via two or more cyclones in series (5a) as present in the upper dome of the reactor vessel of the fluidised bed reactor (5). The separated particles are returned to the fluidised bed in the lower part (6). The gaseous mixture (21) depleted of any entrained particles is supplied to the lower end of a vacuum distillation column (20) which will be described in more detail in FIG. 2.

FIG. 2 shows the vacuum distillation column (20) of FIG. 1. To the lower end of the vacuum distillation column (20) the gaseous mixture (21) is supplied. The gaseous mixture will flow upwards and be subjected to a quenching step. The quenching step is performed in a packed bed (22) through which the gaseous mixture flows upwardly and a liquid quench mixture (26) flows counter-currently and thus downwardly. The resulting rich quenching liquid (26a) is cooled in heat exchanger (23) against evaporating boiler feed water and pumped by pump (25) to be partly used as the liquid quench mixture (26) and partly be discharged via flow (27) as a tar fraction to a tar storage vessel (28). In tar storage vessel the tar is heated to avoid solidification by means of indirect steam heater (29). The liquid tar may be discharged from the process via flow (30).

From the upper end of the vacuum distillation column (20) an overhead stream (31) is discharged and cooled in heat exchanger (32) wherein the gas oil fraction condenses. This liquid fraction is separated from the gaseous hydrocarbons boiling below the gas oil range in a gas-liquid separator (33). The overhead gas (34) as obtained and comprising hydrogen, fuel gas compounds and a naphtha fraction and a liquid gas oil fraction is compressed by compressor (35) and sent to a separation train (not shown). Part of the liquid gas oil fraction (36) is returned as a reflux stream to the vacuum distillation column (20) and part (37) of the liquid gas oil fraction is obtained as the gas oil product and part (39) is combined with part (27a) of the rich quenching liquid (26a) to be used as part of the liquid quench mixture (26). The valves shown in FIGS. 1 and 2 illustrate the many valves which may be present in such a process. The valves may be used to control the relative volumes of flows through the different conduits

What is claimed herein is:

1. A process to prepare a gas oil product from a carbonaceous particles of a biomass source comprising the following steps:
(a) pyrolysis of the carbonaceous particles to a gaseous mixture of hydrocarbons in the absence of oxygen;
(b) quenching the gaseous mixture of hydrocarbons by contacting with a liquid quench mixture of hydrocarbons having a lower temperature than the gaseous mixture thereby obtaining a rich liquid quench mixture and a quenched gas; and
(c) isolating from the quenched gas a gas oil product by means of vacuum distillation;
wherein the liquid gas oil is partly supplied to the top of the vacuum distillation column as a distillation reflux, partly used as part of the liquid quench mixture in (b) and partly discharged as the gas oil product.

2. The process according to claim 1, wherein the liquid quench mixture comprises the gas oil product and hydrocarbons having a higher boiling point than the gas oil product.

3. The process according to claim 2, wherein part of the rich liquid quench liquid is discharged as a tar fraction and part of the rich liquid quench fluid is reused in step (b) in admixture with part of the gas oil product.

4. The process according to claim 3, wherein the temperature of the liquid quench mixture is at least 150° C. lower than the temperature of the rich liquid quench mixture.

5. The process according to claim 1, wherein the vacuum distillation is performed at a pressure of between 0.7 and 145 kPa.

6. The process according to claim 1, wherein step (b) and (c) are performed in the same distillation vessel; and
wherein step (b) is performed at a lower end of the distillation vessel.

7. The process according to claim 1, wherein step (b) is performed in a packed bed or distillation trays including but not limited to bubble cap trays, sieve deck trays, dual flow trays, valve trays, or baffle trays.

8. The process according to claim 1, wherein in step (c) an overhead distillation fraction is partly condensed to obtain the liquid gas oil and a mixture of gaseous hydrocarbons boiling below the gas oil product; and wherein the liquid gas oil product is separated from the mixture of gaseous hydrocarbons by means of a gas-liquid separation.

9. The process according to claim 1, wherein the pyrolysis in step (a) is performed at a temperature of between 500 and 1300 C, at a pressure of between 0.7 kPa and 35 kPa and at a particle residence time of between 20 and 120 seconds.

10. The process according to claim 9, wherein the pyrolysis is performed in a bubbling fluidised bed of the carbonaceous particles of a biomass source.

11. The process according to claim 10, wherein from the bubbling fluidised bed a char product is discharged.

12. The process according to claim 1, wherein the carbonaceous particles of a biomass source are wood particles or fibrous biomass.

13. The process according to claim 1, wherein more than 90 wt % of the particles have a smallest dimension of above 0.3 and a largest dimension of smaller than 2.5 cm.

14. The process according to claim 13, wherein more than 90 wt % of the particles have a smallest dimension of above 0.5 cm and a largest dimension of smaller than 1.3 cm.

15. The process according to claim 1, wherein in step (c) a naphtha product is isolated.
